(19) United States
(12) Patent Application Publication
(10) Pub. No.: US 2014/0110552 A1
(43) Pub. Date: Apr. 24, 2014

(54) SEAT SLIDE APPARATUS FOR VEHICLE

(71) Applicant: AISIN SEIKI KABUSHIKI KAISHA, Kariya-shi (JP)

(72) Inventors: Yukifumi YAMADA, Toyota-shi (JP); Eiichiro Tsuji, Kariya-shi (JP); Mikihito Nagura, Okazaki-shi (JP)

(73) Assignee: AISIN SEIKI KABUSHIKI KAISHA, Kariya-shi (JP)

(21) Appl. No.: 14/050,618

(22) Filed: Oct. 10, 2013

(30) Foreign Application Priority Data
Oct. 19, 2012 (JP) 2012-232224

(51) Int. Cl. B60N 2/07

(52) U.S. Cl. CPC B60N 2/0722
USPC 248/429

(57) ABSTRACT

A seat slide apparatus for a vehicle includes a lock member selectively locking and restricting relative movement between a first and a second rails and a pair of resilient members formed with shaft biasing portions biasing a retaining shaft in a direction opposite to a direction of biasing the lock member. A first and a second end portions of each resilient member are arranged at positions arranging the shaft biasing portions between the first and the second end portions. The first end portion is locked and restrained to the lock member and the second end portion is locked and restrained to the second rail. A first resilient member of the resilient members includes a stress concentrating portion concentrating stress greater than the stress at a second resilient member. The first rail includes a multiple number of engaging portions for engaging with the stress concentrating portion released from the retaining shaft.

### CROSS REFERENCE TO RELATED APPLICATIONS

This application is based on and claims priority under 35 U.S.C. §119 to Japanese Patent Application 2012-232224, filed on Oct. 19, 2012, the entire content of which is incorporated herein by reference.

### TECHNICAL FIELD

This disclosure generally relates to a seat slide apparatus for a vehicle.

### BACKGROUND DISCUSSION

A known seat slide apparatus for a vehicle is disclosed, for example, in JP2008-184033A, hereinafter referred to as Reference 1. As FIG. 9 illustrates, the known seat slide apparatus for a vehicle in Reference 1 includes a lower rail 101, an upper rail 102 connected to the lower rail 101 to be movable in a longitudinal direction relative to the lower rail 101, and a lock member 103 arranged within a void formed between the lower rail 101 and the upper rail 102. The lock member 103 is rotationally connected to a rivet 105 that is fixed to the upper rail 102 via a pin 104 having an axis extending in a width direction such that the lock member 103 rotates in an upward-downward direction. Furthermore, movement of the upper rail 102 relative to the lower rail 101 is locked and restrained by a lock spring 106 applying a biasing force to move the lock member 103 in an upward direction, the biasing force that makes a locking portion 103a formed as a quadrilateral through-hole formed on the lock member 103 to fit into a locking protrusion 101b having a saw-tooth form formed on a flange 101a. In addition, an operational force at an operation member moves the lock member 103 in a downward direction against the biasing force of the lock spring 106, which in turn makes the locking protrusion 101b detach from the locking portion 103a, so that the upper rail 102 is released from a locked and restrained state and is allowed to move relative to the lower rail 101.

Note that, one end of the lock spring 106 is fixed to the upper rail 102 and the other end is in resilient contact with a downward surface of the lock member 103 so that the lock spring 106 biases the lock member 103 in the upward direction.

In a case where the lock spring 106 of the known seat slide apparatus for a vehicle in Reference 1 is broken and damaged, for example, as a result of usages over allowable stress limit or as a result of number of usages exceeding a fatigue limit, the locked and restrained state of the upper rail 102 relative to the lower rail 101 provided by the lock member 103 may become unstable. Favorably, when the lock spring 106 is broken and damaged, a user is promptly informed of the condition so that the user recognizes the condition.

A need thus exists for a seat slide apparatus for a vehicle, which is not susceptible to the drawbacks mentioned above.

### SUMMARY

A seat slide apparatus for a vehicle includes a first rail including a pair of flanges arranged side by side in a width direction where an end of each of the pair of flanges is formed with a multiple number of locking protrusions, a second rail connected to the first rail to be relatively movable, a lock member connected to the second rail to rotate about an axis extending in the width direction, the lock member formed with a locking portion configured to receive the locking protrusion to fit into the locking portion, the lock member selectively locking and restricting relative movement between the first rail and the second rail by the locking protrusion removably fitting into the locking portion in response to rotational movement of the lock member, a pair of resilient members rotationally biasing the lock member in a direction to lock and restrict the relative movement between the first rail and the second rail, and an operation member configured to transmit an operational force to the lock member for releasing the first rail and the second rail from a locked and restricted state to allow the relative movement between the first rail and the second rail. The lock member connects to the second rail to be rotatable about a retaining shaft positioned at the axis extending in the width direction, the retaining shaft fixed to either one of the second rail and the lock member and rotationally supports the other one of the second rail and the lock member. Each of the pair of resilient members includes a shaft biasing portion biasing the retaining shaft in a direction opposite to a direction of biasing the lock member and includes a first and a second end portions arranged at positions arranging the shaft biasing portion between the first and the second end portions where the first end portion is locked and restrained to the lock member and the second end portion is locked and restrained to the second rail. A first resilient member of the pair of resilient members includes a stress concentrating portion concentrating stress greater than the stress at a second resilient member of the pair of resilient members, the stress concentrating portion arranged on the shaft biasing portion at one side in the direction of the relative movement between the first rail and the second rail. The first rail is provided with a multiple number of engaging portions arranged next to each other and aligning in a direction of the relative movement between the first rail and the second rail, the engaging portions configured to engage with the stress concentrating portion of the first resilient member released from the retaining shaft.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a side view drawing illustrating a vehicle seat installed with a seat slide apparatus for a vehicle according to this disclosure;

FIG. 2 is an exploded perspective view drawing illustrating an embodiment of the seat slide apparatus for a vehicle according to this disclosure;

FIG. 3A is a cross-sectional drawing taken along line IIIA-IIIA in FIG. 4A illustrating the embodiment of the seat slide apparatus for a vehicle according to this disclosure;

FIG. 3B is another cross-sectional drawing taken along line IIIB-IIIB in FIG. 4A illustrating the embodiment of the seat slide apparatus for a vehicle according to this disclosure;

FIG. 4A is a cross-sectional view drawing taken vertically along a frontward-rearward direction illustrating the embodiment of the seat slide apparatus for a vehicle according to this disclosure;

FIG. 4B is a cross-sectional view drawing taken along line IVB-IVB in FIG. 4A illustrating the embodiment of the seat slide apparatus for a vehicle according to this disclosure;

FIG. 5A is a cross-sectional view drawing taken vertically along the frontward-rearward direction illustrating an operation of the embodiment of the seat slide apparatus for a vehicle according to this disclosure;

FIG. 5B is another cross-sectional view drawing taken vertically along the frontward-rearward direction illustrating the operation of the embodiment of the seat slide apparatus for a vehicle according to this disclosure;

FIG. 6A is a perspective view drawing illustrating a lock spring of the embodiment of the seat slide apparatus for a vehicle according to this disclosure in a free state;

FIG. 6B is a side view drawing illustrating the lock spring of the embodiment of the seat slide apparatus for a vehicle according to this disclosure in the free state;

FIG. 6C is a perspective view drawing illustrating the lock spring of the embodiment of the seat slide apparatus for a vehicle according to this disclosure in an intermediate state during installment process:

FIG. 6D is a side view drawing illustrating the lock spring of the embodiment of the seat slide apparatus for a vehicle according to this disclosure in the intermediate state during installment process;

FIG. 6E is a perspective view drawing illustrating the lock spring of the embodiment of the seat slide apparatus for a vehicle according to this disclosure in an installed state:

FIG. 6F is a side view drawing illustrating the lock spring of the embodiment of the seat slide apparatus for a vehicle according to this disclosure in the installed state;

FIG. 7A is a graph illustrating a relationship between displacement of a first extending portion and stress on the first extending portion;

FIG. 7B is a graph illustrating a relationship between displacement of a second extending portion and stress on the second extending portion;

FIG. 8 is a drawing illustrating a difference between stress at a frontward portion of a wedging portion and stress at a rearward portion of the wedging portion; and

FIG. 9 is an exploded perspective view drawing illustrating a known seat slide apparatus for a vehicle.

### DETAILED DESCRIPTION

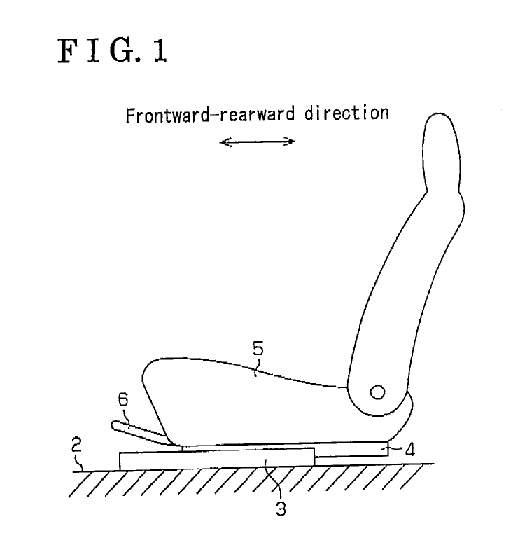

An embodiment of a seat slide apparatus for a vehicle according to this disclosure will be described referring to drawings. Note that, hereinafter, a frontward-rearward direction of a vehicle is referred to as a frontward-rearward direction. As FIG. 1 illustrates, a lower rail 3, which serves as a first rail, is fixed on a vehicle floor 2 in a state where the lower rail 3 extends in the frontward-rearward direction. At the same time, the upper rail 4, which serves as the second rail, is attached to the lower rail 3 so that the upper rail 4 may move in the frontward-rearward direction relative to the lower rail 3. In other words, in the embodiment of the seat slide apparatus for a vehicle, a longitudinal direction of each of the lower rail 3 and the upper rail 4, which is a direction of relative movement between the lower rail 3 and the upper rail 4, conforms to the frontward-rearward direction.

Note that, the lower rail 3 illustrated in FIG. 1 is a leftward lower rail 3 of a pair of lower rails 3 arranged in a width direction, which is the direction perpendicular to the surface where FIG. 1 is drawn. The upper rail 4 illustrated in FIG. 1 is a leftward upper rail 4 of a pair of upper rails 4 arranged in the width direction. The pair of upper rails 4 retains a seat 5 fixed thereon, the seat 5 forming a portion where a passenger seats. As a basic state, the relative movement between the lower rail 3 and the upper rail 4 is in a locked and restrained state. A release handle 6, which serves as an operation member, is provided for releasing the lower rail 3 and the upper rail 4 from the locked and restrained state.

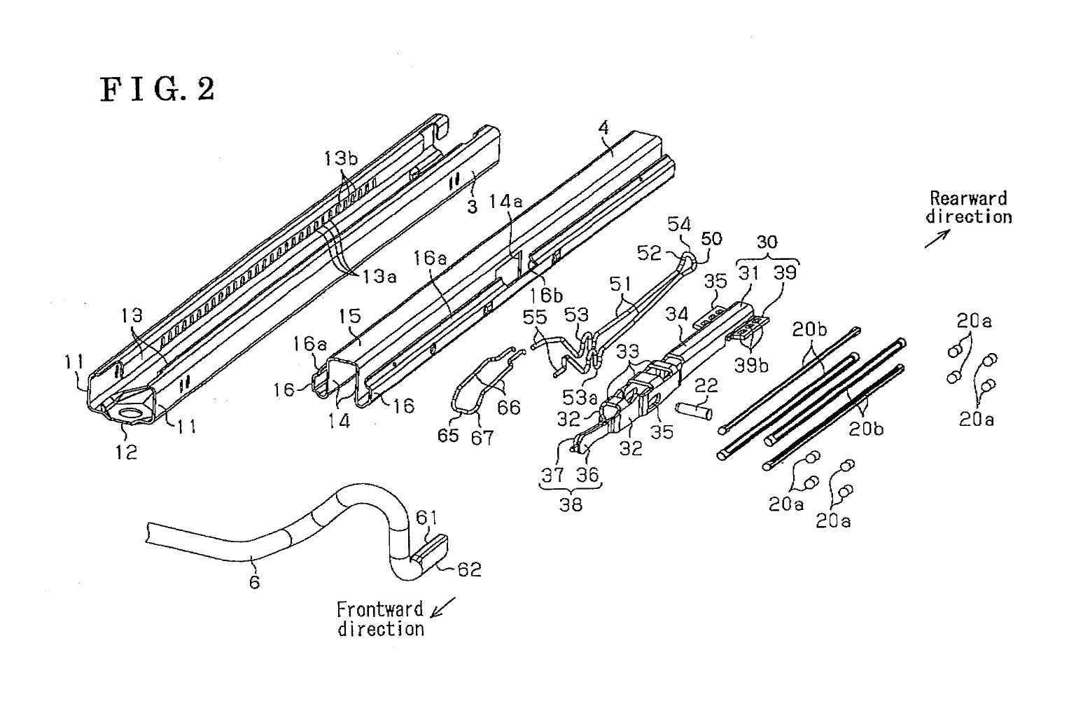

As FIG. 2 illustrates, the lower rail 3 is formed from a plate material. The lower rail 3 includes a pair of side walls 11 extending in an upward-downward direction at each side of the lower rail 3 in the width direction. The lower rail 3 further includes a bottom wall 12 connecting between base ends of the side walls 11, which are downward ends of the side walls 11. Furthermore, at each of distal ends of the side walls 11, which are upward ends of the side walls 11, a flange 13 extending inwardly in the width direction and folded in the downward direction toward the base end of the side wall 11 is continuously formed.

Note that, at an intermediate portion in a longitudinal direction of each of the flange 13 of the lower rail 3, a multiple number of cut-out portions 13a are formed. Each of the cut-out portions 13a is recessed in an upward direction from an end of the flange 13, which is a downward end of the flange 13. The cut-out portions 13a are spaced apart from each other with a predetermined distance between each of the cut-out portions 13a. At the same time, between the cut-out portions 13a adjacent to each other locking protrusions 13b, each of which is formed in a quadrilateral tooth form, are formed. In other words, a multiple number of locking protrusions 13b are arranged in a line in the longitudinal direction of the lower rail 3 with a predetermined distance between each of the locking protrusions 13b.

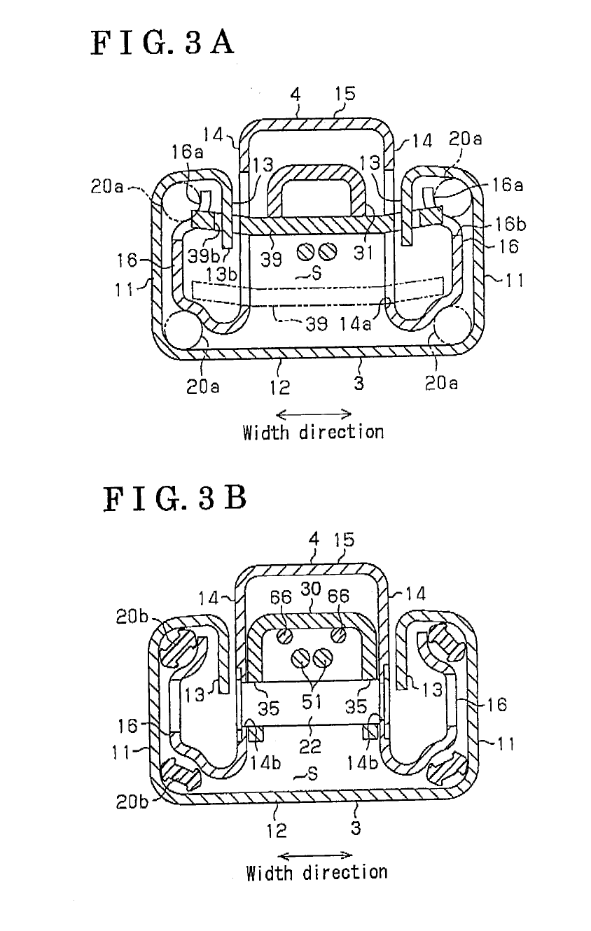

The upper rail 4 is formed from a plate material. As each of FIGS. 3A and 3B illustrates, the upper rail 4 includes a pair of inner flanges 14 extending in the upward-downward direction between the flanges 13 of the lower rail 3 and a top wall 15 connecting between base ends of the inner flanges 14 distantly positioned from the lower rail 3, which are upward ends of the inner flanges 14. The upper rail 4 further includes outer flanges 16, each of which is continuously formed from each of distal ends, which are downward ends, of the inner flanges 14. Each of the outer flanges 16 extends outwardly from each of the distal ends of the inner flanges 14 in the width direction and folded upwardly such that the outer flange 16 is surrounded by the side wall 11 and the flange 13.

In other words, each of the lower rail 3 and the upper rail 4 is a rail formed in a form having a U-shape cross-section and arranged in a state where openings of the U-shapes are facing each other. Furthermore, the lower rail 3 and the upper rail 4 are restrained from pulled off from each other in the upward-downward direction being engaged mainly at the flanges 13 and the outer flanges 16. A shape formed by the cross-section of the rails formed by the lower rail 3 and the upper rail 4 is substantially a rectangle, or a box shape. The lower rail 3 and the upper rail 4 together form a void S.

Note that, a multiple number of spherical balls 20a are arranged between a downward end portion of each of the outer flanges 16 and a downward end portion of each of the side walls 11 facing the downward end portion of each of the outer flanges 16. Similarly, a multiple number of spherical balls 20a are arranged between an upward end portion of each of the outer flanges 16 and an upward end portion of each of the side walls 11 facing the upward end portion of each of the outer flanges 16. The upward end portion of each of the outer flanges 16 is formed with a guide portion 16a curved inwardly in the width direction as the outer flange 16 extends upwardly to form an arc form conforming to an external form of the ball 20a.

As FIG. 2 illustrates, each of the balls 20a is attached to a holder 20b formed in resin, or a similar material, extending in the frontward-rearward direction, which is the longitudinal direction of the lower rail 3 and the upper rail 4. A pair of balls 20a are arranged at a frontward end portion of the holder 20b. Another pair of balls 20a are arranged at a rearward end portion of the holder 20b. Accordingly, total of four balls 20a are attached to each holder 20b. The upper rail 4 is slidably supported to the lower rail 3 so that the upper rail 4 slides in the longitudinal direction, which is the frontward-rearward direction, relative to the lower rail 3. The upper rail 4 slides relative to the lower rail 3 by making each ball 20a roll between the upper rail 4 and the lower rail 3.

Each of the inner flanges 14 of the upper rail 4 is formed with an inner opening 14a having a substantially quadrilateral shape at an intermediate portion of each of the inner flanges 14 in the longitudinal direction. At the same time, the upward end portion of each of the outer flange 16 of the upper rail 4, more specifically at the guide portion 16a, is formed with an outer opening 16b having a substantially quadrilateral shape at a position in the longitudinal direction of the upper rail 4 that corresponds to the position of the inner opening 14a. The inner openings 14a and the outer openings 16b communicate in the width direction. More specifically, the outer openings 16b are cut-out portions having an upward portion being open.

As FIG. 3B illustrates, each of the inner flanges 14 is formed with a shaft attaching through-hole 14b having a circular shape formed at a position in the frontward direction of the vehicle relative to the inner opening 14a. The shaft attaching through-holes 14b are concentric to each other and communicate with each other in the width direction. Each of the inner flanges 14 retains a retaining shaft 22 formed in a solid cylinder form inserted through the shaft attaching through-holes 14b. Each end of the retaining shaft is fixed to the shaft attaching through-holes 14b and retained thereat. Note that, an axis of the retaining shaft 22 extends in the width direction.

A lock lever 30, which serves as a lock member, is retained by the retaining shaft 22 and rotationally connected to the upper rail 4 at an inwardly position in the width direction between each of the inner flanges 14. More specifically, as FIG. 2 illustrates, the lock lever 30 includes a stem portion 31, which is a portion extending in the frontward-rearward direction formed from a plate material. The lock lever 30 further includes a lock plate 39 formed from a plate material fixed to a downward portion of the stem portion 31 at a rearward portion of the stem portion 31. The stem portion 31 includes a pair of vertical wall portions 32 arranged upright and side by side in the width direction. The mentioned pair of vertical wall portions 32 extends in the longitudinal direction of the stem portion 31. A distance between the vertical wall portions 32 in the width direction is defined shorter than a distance between the inner flanges 14 of the upper rail 4 in the width direction. Furthermore, the vertical wall portions 32 are connected by a multiple number of connecting wall portions 33 at frontward portions of each of the vertical wall portions 32. More specifically, three connecting wall portions 33 arranged in the frontward-rearward direction connect between upward ends of the vertical wall portions 32 in the width direction. Furthermore, a top wall portion 34 connects between upward ends of the vertical wall portions 32 in the width direction at a rearward portion of each of the vertical wall portions 32.

Each of the vertical wall portions 32 is formed with an elongate through-hole 35 elongating in the frontward-rearward direction at a position substantially at a height of the retaining shaft 22 and the shaft attaching through-holes 14b. An opening width of the elongate through-hole 35 in a short direction, which is the upward-downward direction, is defined as substantially equal to a diameter of the retaining shaft 22. The retaining shaft 22 is inserted though each of the elongate through-holes 35 and each end of the retaining shaft 22 is fixed at each of the shaft attaching through-holes 14b in a state where each of the vertical wall portions 32 of the stem portion 31 is arranged between each of the inner flanges 14 of the upper rail 4. Accordingly, the stem portion 31 is connected to the upper rail 4 to be rotatable in the upward-downward direction relative to the upper rail 4 in a state where the stem portion 31 is allowed to move in the frontward-rearward direction within a range of the elongate through-hole 35.

Note that, the stem portion 31 includes a pair of insert form portions 36, 37, each of which extends in the frontward direction of a vehicle from a frontward end of each of the vertical wall portions 32 at a downward portion of each of the vertical wall portions 32. Each of the insert form portions 36, 37 is reduced in size in the upward-downward direction relative to the size at the frontward ends of the vertical wall portions 32. As each of the pair of insert form portions 36, 37 extends in the frontward direction, each of the pair of insert form portions 36, 37 approaches each other in the width direction to form a two-ply form. The insert form portions 36, 37 formed as described herewith together serve as a handle insertion portion 38.

The lock plate 39 extends in each of the frontward-rearward direction and the width direction in a state such that the lock plate 39 penetrates through each of the inner openings 14a and each of the outer openings 16b. The lock plate 39 is formed with a multiple number of locking through-holes 39h, each of which serves as a locking portion. The locking through-holes 39b are arranged at outwardly positions relative to each of the vertical wall portions 32, arranged in a line in the frontward-rearward direction with a predetermined distance between each other. In the embodiment of the seat slide apparatus for a vehicle, the lock plate 39 is provided with three locking through-holes 39b at each of the outwardly positions relative to each of the vertical wall portions 32. As FIG. 3A illustrates, each of the locking through-holes 39b extends between the upward surface and the downward surface of the lock plate 39 at a position facing the flange 13. More specifically, the locking through-holes 39b are configured to engage with a multiple number of locking protrusions 13b arranged adjacent to each other in the longitudinal direction of the lower rail 3. More specifically, in the embodiment of the seat slide apparatus for a vehicle, the locking through-holes 39b are configured to engage with three locking protrusions 13b adjacent to each other.

As solid lines illustrating the lock plate 39 in FIG. 3A shows, in a state where the lock lever 30 rotates about the retaining shaft 22 such that the lock plate 39 moves in the upward direction, each of the locking through-holes 39b are configured to receive the locking protrusion 13b corresponding to each of the locking through-holes 39b. In a state where each of the locking through-holes 39b receives the locking protrusion 13b corresponding to each of the locking through-holes 39b, the relative movement between the lower rail 3 and the upper rail 4 is locked and restrained. In contrast, as two-dot chain lines illustrating the lock plate 39 in FIG. 3A shows, in a state where the lock lever 30 rotates about the retaining shaft 22 such that the lock plate 39 moves in the downward direction, each of the locking through-holes 39b are configured to disengage with the locking protrusion 13b corresponding to each of the locking through-holes 39b. At this time, the lower rail 3 and the upper rail 4 is released from a state in which the relative movement between the lower rail 3 and the upper rail 4 is locked and restrained so that the relative movement between the lower rail 3 and the upper rail 4 is allowed.

Note that, a size of the lock plate 39 in the width direction is defined as a size larger than a distance in the width direction between each of the guide portions 16a of the upper rail 4 and smaller than a distance in the width direction between each of the outer flanges 16 at a position in the downward direction relative to the guide portion 16a. Accordingly, the lock plate 39 penetrates through the outer openings 16b in a state where the relative movement between the lower rail 3 and the upper rail 4 is locked and restrained while the lock plate 39 is restrained from interfering with the outer flanges 16 in a state where the lower rail 3 and the upper rail 4 is released from the state in which the relative movement between the lower rail 3 and the upper rail 4 is locked and restrained.

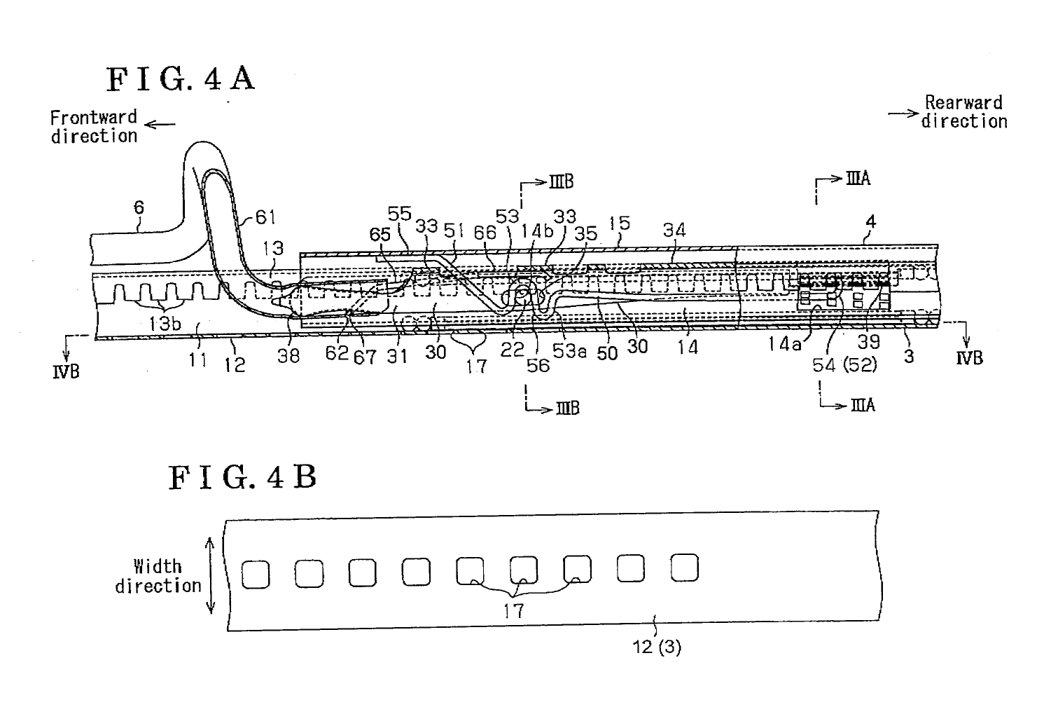

As FIG. 2 illustrates, a lock spring 50 formed from a single wire material is arranged within the upper rail 4. The lock spring 50 in a top view is substantially formed in a U-shape with an opening in the frontward direction. The lock spring 50 includes a pair of extending portions 51 in left-right symmetry extending in the frontward-rearward direction. Note that, the extending portions 51 serve as a pair of resilient members. The lock spring 50 further includes a connecting portion 52, which is a curved portion having a bow form, connecting between rearward ends of the pair of extending portions 51 to connect the pair of extending portions 51 in the width direction. As FIG. 4A illustrates, the lock spring 50 includes a wedging portion 53, which serves as a shaft biasing portion, on each of the extending portions 51. Each of the wedging portions 53 is curved to bulge in the upward direction at an intermediate portion in the longitudinal direction of each of the extending portions 51. The lock spring 50 further includes a lever-side locking end portion 54 formed by bending the connecting portion 52 in the upward direction. Furthermore, a front end portion of each of the extending portions 51 forms a rail-side locking end portion 55. Note that, the lever-side locking end portion 54 serves as the first end portion and the rail-side locking end portion 55 serves as the second end portion.

The lock spring 50 is substantially arranged within the stem portion 31 in a state where each of the rail-side locking end portions 55 projects upwardly from a portion between adjacent connecting wall portions 33 of the stem portion 31 arranged at positions in the frontward direction relative to the retaining shaft 22. Furthermore, the lock spring 50 is retained, for example, to the upper rail 4 by arranging each of the wedging portions 53 from the upward direction of the retaining shaft 22 so that the retaining shaft 22 is inserted between each of the wedging portions 53, by inserting and fixing the lever-side locking end portion 54 into the lock plate 39 from the downward direction of the lock plate 39, and by making each of the rail-side locking end portion 55 contact with a downward surface of the top wall 15 of the upper rail 4.

At this time, the lock spring 50 rotationally biases the lock lever 30 in a direction in which the lock plate 39 moves in the upward direction at rear end portions of the extending portions 51. In other words, the lock spring 50 rotationally biases the lock lever 30 in a direction in which the locking protrusion 13b fits into a corresponding locking through-hole 39b. Furthermore, a reaction force of the lock spring 50 locks and restrains movement of the retaining shaft 22 in the frontward-rearward direction within the elongate through-hole 35 by biasing the retaining shaft 22 at each of the wedging portions 53 in the downward direction, which is the direction perpendicular to the longitudinal direction of the elongate through-hole 35. More specifically, the position of the retaining shaft 22 in the frontward-rearward direction within the elongate through-hole 35 is retained by each of the wedging portions 53 of the lock spring 50 biasing the retaining shaft 22. In the embodiment of the seat slide apparatus far a vehicle, the retaining shaft 22 is biased and retained at a central portion of the elongate through-hole 35 in the frontward-rearward direction. Accordingly, in a case where each of the extending portions 51 is considered as a beam, moment at the wedging portion 53, which is where the retaining shaft 22 is inserted between, becomes maximum so that stress generated thereat likewise becomes maximum. Note that the lock spring 50 includes curved and bulged portions 53a, each of which is formed by curving and bulging a portion in a rearward direction relative to each of the wedging portions 53 in the downward direction.

Note that, one of the extending portions 51, which is referred to as a first extending portion 51A serving as a first resilient member, includes a stress concentrating portion 56 at a portion of the wedging portion 53 at one side in the frontward-rearward direction, which in a case in the embodiment of the seat slide apparatus for a vehicle is a rearward portion of the wedging portion 53. At the stress concentrating portion 56, greater stress is concentrated compared to the other one of the extending portions 51, which is referred to as a second extending portion 51B serving as a second resilient member.

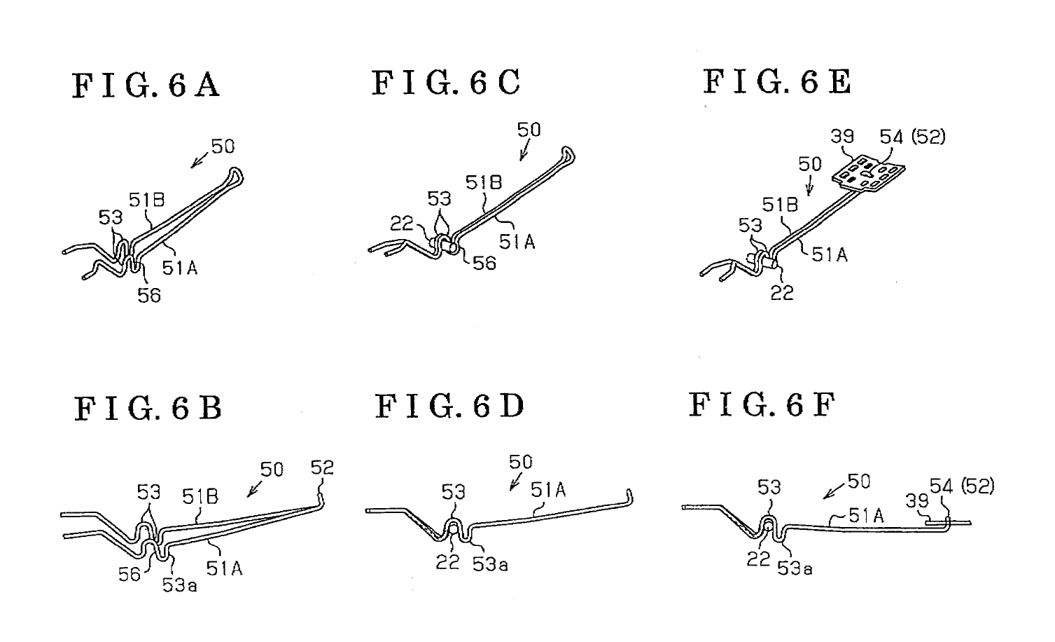

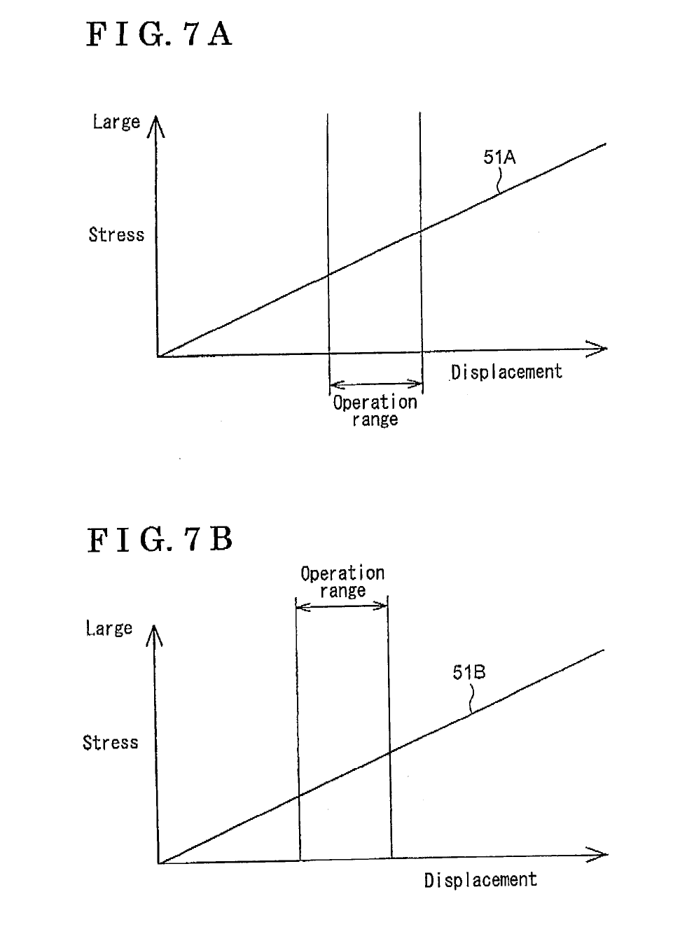

More specifically, as changes of states of the lock spring 50 illustrated in FIGS. 6A to 6F show, the first extending portion 51A is arranged to resiliently deform more between a free state and an installed state compared to the second extending portion 51B by wrenching the first extending portion 51A at the connecting portion 52. Furthermore, as FIGS. 7A and 7B illustrate, in a state where an operating condition of the lock lever 30 is common within an operation range of the lock lever 30, which is a rotation range of the lock lever 30, displacement of the first extending portion 51A and the stress generating on the first extending portion 51A in accordance with the displacement of the first extending portion 51A is defined to be always larger than displacement of the second extending portion 51B and the stress generating on the second extending portion 51B in accordance with the displacement of the second extending portion 51B. In other words, within entire range of the operation range of the lock lever 30, greater stress concentrates on the first extending portion 51A compared to the stress on the second extending portion 51B.

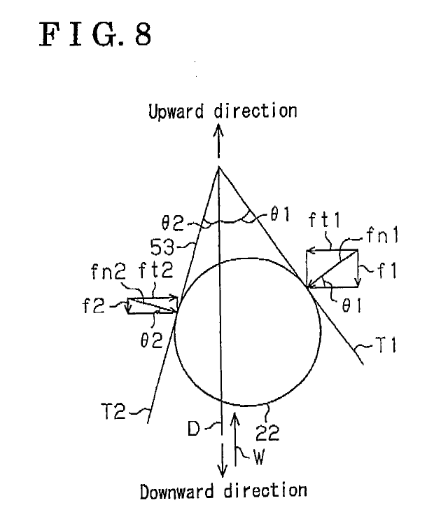

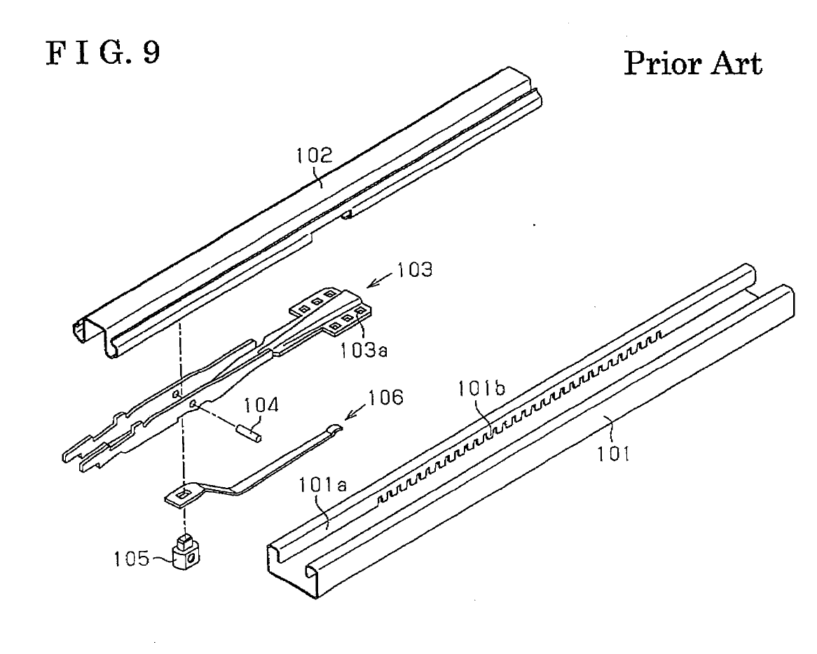

Furthermore, as FIG. 8 illustrates in a simplified manner, a first direction of tangential line is indicated as T1. The first direction of tangential line T1 is defined at a rearward portion of the wedging portion 53, which in other words is a portion of the wedging portion 53 in pressure contact with the retaining shaft 22 at one side in the frontward-rearward direction. A second direction of tangential line is indicated as T2. The second direction of tangential line T2 is defined at a frontward portion of the wedging portion 53, which in other words is a portion of the wedging portion 53 in pressure contact with the retaining shaft 22 at an opposite side relative to the mentioned one side in the frontward-rearward direction. A slant angle θ1, which is an angle formed between the first direction of tangential line T1 and a biasing direction D of the wedging portion 53, which is the downward direction, is defined such that the slant angle θ1 is formed closer to a right angle compared to a slant angle θ2, which is an angle formed between the second direction of tangential line T2 and the biasing direction D of the wedging portion 53. Accordingly, a biasing force f1, which is a force the rearward portion of the wedging portion 53 biasing the retaining shaft 22 in the downward direction, becomes larger than a biasing force f2, which is a force the frontward portion of the wedging portion 53 biasing the retaining shaft 22 in the downward direction.

More specifically, a load the wedging portion 53 receives from the retaining shaft 22 is indicated with W. A normal direction component as a result of a wedge effect at a portion at which the rearward portion of the wedging portion 53 and the retaining shaft 22 contact is indicated as fn1. A normal direction component as a result of the wedge effect at a portion at which the frontward portion of the wedging portion 53 and the retaining shaft 22 contact is indicated as fn2. Furthermore, a horizontal direction component of the normal direction component fn1 is indicated as ft1 and a horizontal direction component of the normal direction component fn2 is indicated as ft2. Due to forces balancing each other, following relationships (1) and (2) establish.

W=f1+f2 (1)

ft1=ft2 (2)

Furthermore, following relationships establish,

ft1=f1/tan θ1

ft2=f2/tan θ2

By substituting above relationships to the relationship (2), following relationship is obtained.

f2=f1×tan θ2/tan θ1

Accordingly, following relationships are obtained.

W=f1×(tan θ1+tan θ2)/tan θ1

f1=W×tan θ1/(tan θ1+tan θ2)

f2=W×tan θ2/(tan θ1+tan θ2)

As a result, in a state where θ1 is greater than θ2, which may be expressed as θ1>θ2, f1 becomes greater than f2, which may be expressed as f1>f2.

The stress concentrating portion 56 is formed accordingly. More specifically, the stress concentrating portion 56 is formed such that the stress generating at the rearward portion of the wedging portion 53 of the first extending portion 51A becomes greater compared to the stress generating at the frontward portion of the wedging portion 53. In addition, the stress concentrating portion 56 is formed such that the stress generating at the rearward portion of the wedging portion 53 of the first extending portion 51A becomes greater compared to the rearward portion of the wedging portion 53 of the second extending portion 51B.

As FIG. 4B illustrates, at a central portion in the width direction of the bottom wall 12 of the lower rail 3 is formed with a multiple number of engaging through-holes 17, which serves as the engaging portions. Each of the engaging through-holes 17 is formed in a quadrilateral. The engaging through-holes 17 are formed at intervals in a line in the frontward-rearward direction. Each of the engaging through-holes 17 extends between the upward surface and the downward surface of the bottom wall 12 of the lower rail 3 at a position facing the first extending portion 61A. Each of the engaging through-holes 17 is arranged at a position configured to engage with the curved and bulged portion 53a at the stress concentrating portion 56, which is released from the retaining shaft 22.

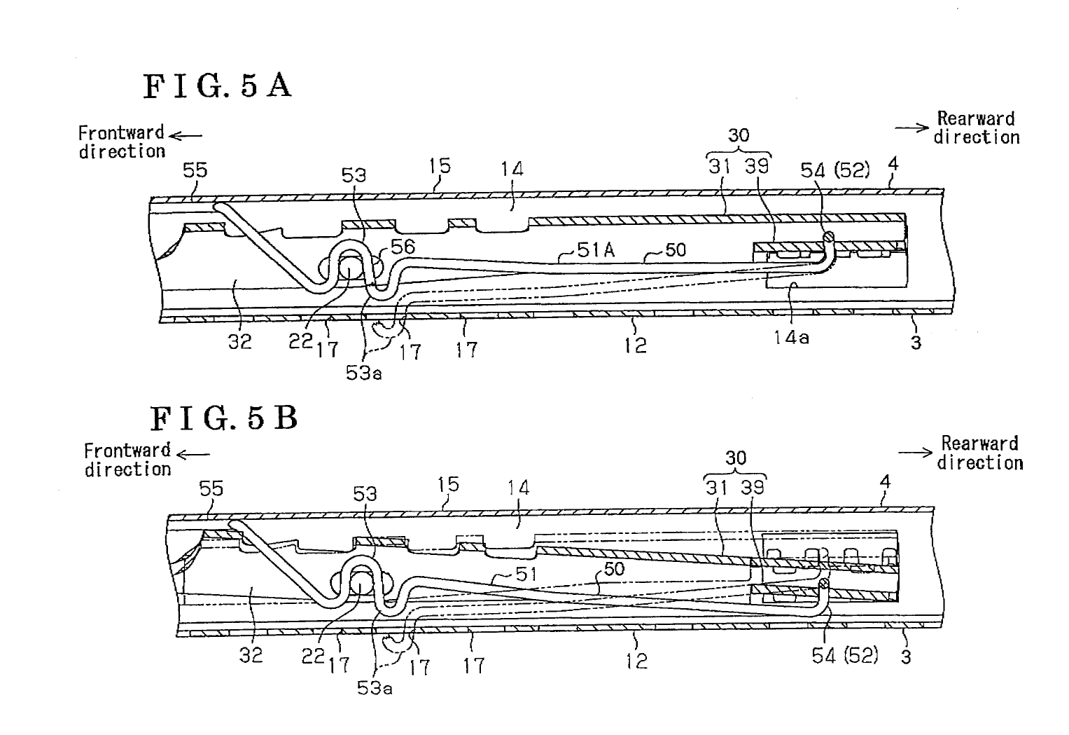

Accordingly, as FIGS. 5A and 5B illustrate, when the first extending portion 51A breaks off at the stress concentrating portion 56 while the lock lever 30 is in a locked and restrained state that locks and restrains relative movement of the upper rail 4 relative to the lower rail 3, the stress concentrating portion 56, or the curved and bulged portion 53a, released from the retaining shaft 22 is resiliently restored and becomes engageable with any one of the multiple number of engaging through-holes 17. Accordingly, movement in the frontward-rearward direction of the lock lever 30 is locked and restrained relative to the lower rail 3, the lock lever 30 that is where the rear end portion of the first extending portion 51A, which is connected to the stress concentrating portion 56, is fixed at.

As FIG. 2 illustrates, the release handle 6, which is formed by bending a tubular material, is formed such that the release handle 6 bridges between frontward end portions of the pair of upper rails 4 in the width direction. End portions 61 of the release handle 6 extend in the rearward direction. Each of the end portions 61 is formed in a flattened hollow cylinder form that is flattened in the width direction. Each of the end portions 61 is provided with an inner diameter in the width direction that is larger than a dimension of the handle insertion portion 38 in the width direction. Each of the end portions 61 is provided with an outer diameter in the width direction that is smaller than the distance between the inner flanges 14 in the width direction. The end portions 61 are inserted into the upper rails 4 from frontward end openings of the upper rails 4. The end portions 61 are connected to the lock levers 30 by the handle insertion portions 38 inserted into the end portions 61. Accordingly, the end portions 61 substantially make rotational movements integrally with the lock levers 30 about the retaining shafts 22. Note that, at a downward portion of each of the end portions 61, a retaining groove 62 formed in a slit form extending in the width direction is formed.

Within each of the upper rails 4, a handle spring 65 formed from a single wire material is arranged. The handle spring 65 is substantially formed in a U-shape in a top view with an opening in the rearward direction. The handle spring 65 includes a pair of extending parts 66 in left-right symmetry extending in the frontward-rearward direction. The handle spring 65 further includes a connecting part 67 connecting between frontward ends of the extending parts 66 to connect the extending parts 66 in the width direction.

As FIG. 4A illustrates, the connecting part 67 of the handle spring 65 is fitted into the retaining groove 62 formed on the end portion 61 of the release handle 6, which is in a state where the handle insertion portion 38 is inserted into. Rear end portions of the extending parts 66 are arranged to contact with a downward surface of the connecting wall portion 33 on the stem portion 31 of the lock lever 30 at a portion in the rearward direction of the vehicle relative to the retaining shaft 22. Accordingly, the end portions 61 are biased to move in the upward direction at the retaining groove 62 by the handle spring 65. Note that, the handle spring 65, which is arranged at a position in the downward direction relative to the rail-side locking end portion 55, is arranged to avoid interfering with the lock spring 50 by arranging each of the extending parts 66, which extends in the rearward direction of the vehicle from the connecting part 67 and extends upward toward the downward surface of the connecting wall portion 33, outward in the width direction relative to the lock spring 50 at a position in the rearward direction relative to the rail-side locking end portion 55.

A front end portion of the handle insertion portion 38 is inserted into the end portion 61 to retain the end portion 61 in a state where the end portion 61 is swingable in the upward-downward direction at a position in the frontward direction of the vehicle relative to the retaining groove 62, which is the position where the end portion 61 is biased by the handle spring 65. Posture of the end portion 61 is controlled by the end portion 61 being biased in the upward direction at the retaining groove 62 by the handle spring 65.

Accordingly, when frontward end of the end portion 61 is raised, the end portion 61 and the lock lever 30 integrally pivot about the retaining shaft 22 in the downward direction that makes the lock plate 39 move in the downward direction against a biasing force of the lock spring 50, which is the direction that makes the locking through-hole 39b detach from the locking protrusion 13b corresponding to the locking through-hole 39b.

In a state where an operational force is not exerted on the release handle 6, relative movement between the lower rail 3 and the upper rail 4 is locked and restrained by the biasing force of the lock spring 50. The biasing force of the lock spring 50 makes the end portion 61 of the release handle 6 and the lock lever 30 integrally rotate about the retaining shaft 22 in the upward direction and makes the lock plate 39 move in the upward direction, which is the direction that makes the locking through-hole 39b fit into the locking protrusion 13b corresponding to the locking through-hole 39b. Accordingly, a position of the seat 5 retained on the upper rails 4 in the frontward-rearward direction is retained.

In a state where the release handle 6 is operated such that front end of the release handle 6 is raised in the upward direction, the lock levers 30 integrally rotate about the retaining shafts 22 against the biasing force of the lock springs 50 making the lock plate 39 move in the downward direction, which is the direction that makes the locking through-hole 39b detach from the locking protrusion 13b corresponding to the locking through-hole 39b. Accordingly, the upper rail 4 is released from a state of being locked and restrained to the lower rails 3 so that the relative movement between the lower rails 3 and the upper rails 4 is allowed. As a result, the position of the seat 5 retained on the upper rails 4 in the frontward-rearward direction becomes adjustable.

An operation of the embodiment of the seat slide apparatus for a vehicle will be described next. In a state where the lock spring 50, or each of extending portions 51, is used over an allowable stress limit or used more than a number of times defined as a fatigue limit and the first extending portion 51A having the stress concentrating portion 56 breaks off at the stress concentrating portion 56 while the lock lever 30 is in the locked and restrained state that locks and restrains movement of the upper rail 4 relative to the lower rail 3, as FIG. 5A illustrates, the stress concentrating portion 56, or the curved and bulged portion 53a, released from the retaining shaft 22 is resiliently restored and becomes engageable with any one of the multiple number of engaging through-holes 17. Accordingly, movement in the frontward-rearward direction of the lock lever 30 is locked and restrained relative to the lower rail 3, the lock lever 30 that is where the rear end portion of the first extending portion 51A, which is connected to the stress concentrating portion 56 that is the break off portion, is fixed at.

In a state where the release handle 6 is raised in the upward direction from the above-described state, as FIG. 58 illustrates, each of the lock levers 30 rotates about the retaining shaft 22 making the lock plate 39 move in the downward direction, which is the direction that makes the locking through-hole 39b detach from the locking protrusion 13b corresponding to the locking through-hole 39b. Nevertheless, the relative movement between the lower rail 3 and the upper rail 4 is maintained in a locked and restrained state as a result of the stress concentrating portion 56, or the curved and bulged portion 53a, being engaged with the engaging through-hole 17. Accordingly, a user may be informed of an abnormal condition and may recognize the abnormal condition from the seat 5 being restrained from positional adjustment in the frontward-rearward direction.

Upon the arrangement described herewith, the embodiment of the seat slide apparatus for a vehicle is advantageous in following aspects. Firstly, in the embodiment of the seat slide apparatus for a vehicle, when the first extending portion 51A breaks off at the stress concentrating portion 56, the first extending portion 51A released from the retaining shaft 22 is resiliently restored and becomes engageable with any one of the multiple number of engaging through-holes 17. Accordingly, movement of the lock lever 30 in the frontward-rearward direction is locked and restrained relative to the lower rail 3. A movement restrained state produced by the stress concentrating portion 56, which is the break off portion, is not releasable by the operational force exerted from the release handle 6. Accordingly, a user is informed of an abnormal condition and recognizes the abnormal condition at a time at which the release handle 6 is operated next time at latest.

Furthermore, the lock lever 30 is rotationally biased in the direction to lock and restrain the relative movement between the lower rail 3 and the upper rail 4 by the second extending portion 51B provided without the stress concentrating portion 56, the second extending portion 51B that is not broken off. Accordingly, the locked and restrained state of the relative movement between the lower rail 3 and the upper rail 4 provided by the lock lever 30 becoming unstable may be restrained.

Secondly, in the embodiment of the seat slide apparatus for a vehicle, integrating the first extending portion 51A and the second extending portion 51B into the lock spring 50 is advantageous in reducing number of components. Thirdly, in the embodiment of the seat slide apparatus for a vehicle, the stress concentrating portion 56 may be provided with simple adjustment of the slant angles θ1, θ2 formed between the first and the second directions of tangential lines T1, T2 at the portions of the wedging portion 53 in pressure contact with the retaining shaft 22 at each side and the biasing direction of the wedging portion 53.

Fourthly, in the embodiment of the seat slide apparatus for a vehicle, the stress concentrating portion 56, which is the break off portion, of the first extending portion 51A released from the retaining shaft 22 fits into any one of the multiple number of engaging through-holes 17 when the first extending portion 51A breaks off at the stress concentrating portion 56 so that the movement of the lock lever 30 relative to the lower rail 3 in the frontward-rearward direction is locked and restrained. At this time, the stress concentrating portion 56, or the curved and bulged portion 53a, fitted into the engaging through-hole 17 is exposed to outside of the lower rail 3 by the stress concentrating portion 56 penetrating through the engaging through-hole 17. Accordingly, the stress concentrating portion 56 may be pushed out from the engaging through-hole 17 by using an appropriate tool so that the lock lever 30 is released from a state of being locked and restrained by the stress concentrating portion 56 to allow movement of the lock lever 30 in the frontward-rearward direction with an easy procedure. Accordingly, a work efficiency for replacing the first extending portion 51A, or the lock spring 50, which is broken off at the stress concentrating portion 56, may be enhanced.

Fifthly, in the embodiment of the seat slide apparatus for a vehicle, the stress concentrating portion 56 may be provided with a simple adjustment of the amount of resilient deformation, or displacement, of the first extending portion 51A and the second extending portion 51B relative to free states of each of the first extending portion 51A and the second extending portion 51B within an operation range of the lock lever 30.

Note that, the embodiment of the seat slide apparatus for a vehicle may be appropriately altered in following manners. The connecting portion 52 in the seat slide apparatus according to the embodiment may be a connecting portion connecting between frontward ends of the pair of extending portions 51, which are the first extending portion 51A and the second extending portion 518, to connect the mentioned pair of extending portions 51 in the width direction.

The mentioned pair of extending portions 51, which are the first extending portion 51A and the second extending portion 51B, in the seat slide apparatus according to the embodiment may be components independent from each other. Each of the rail-side locking end portions 55 in the seat slide apparatus according to the embodiment may be altered to engage with the top wall 15 of the upper rail 4 and fixed thereat.

The stress concentrating portion 56 of the first extending portion 51A in the seat slide apparatus according to the embodiment may be arranged at a frontward portion of the wedging portion 53 that is in pressure contact with the retaining shaft 22. In this case, each of the rail-side locking end portions 55 is engaged with the top wall 15 of the upper rail 4 and fixed thereat. The lever-side locking end portions 54 may be engaged with the lock plate 39 and fixed thereat or may be left in a state where the lever-side locking end portions 54 are merely in contact with a downward surface of the lock plate 39.

The engaging through-holes 17 in the seat slide apparatus for a vehicle according to the embodiment are through-holes where the stress concentrating portion 56, which is the break off portion, engage, however, each of the engaging through-holes 17 may be altered to be formed in a form of a groove that is recessed in the downward direction that is not communicating in the upward-downward direction. The lock plate 39 in the seat slide apparatus for a vehicle according to the embodiment may be provided with locking recesses open in the width direction instead of the locking through-holes 39b. In other words, the lock plate 39 may be in a comb-teeth form.

A configurational relationship may be switched between the upper rail 4 and the lock lever 30 or between the retaining shaft 22 and the elongate through-holes 35 in the seat slide apparatus for a vehicle according to the embodiment. In such a case, the upper rail 4 may be provided with elongate recesses, or grooves, not communicating in the width direction, instead of providing the elongate through-holes 35 on the lock lever 30.

The retaining shaft 22 in the seat slide apparatus for a vehicle according to the embodiment may be fixed to the upper rail 4 via an appropriate bracket. The lock lever 30 in the seat slide apparatus for a vehicle according to the embodiment may be formed with circular through-holes on the stem portion 31 instead of the elongate through-holes 35. The retaining shaft 22 may be fitted to the circular through-holes by inserting the retaining shaft 22 through the circular through-holes so that the lock lever 30 is rotationally connected to the upper rail 4. Note that, configurational relationship may be switched between the upper rail 4 and the lock lever 30 or between the retaining shaft 22 and the circular through-holes.

The lower rail 3 in the seat slide apparatus for a vehicle according to the embodiment may be in a structure formed by a multiple number of plate materials bonded, for example, by welding. Note that, a cross-sectional shape of the lower rail 3 of the seat slide apparatus for a vehicle according to the embodiment is an example and may be altered on condition that the lower rail 3 includes a pair of flanges having locking protrusions.

The upper rail 4 in the seat slide apparatus for a vehicle according to the embodiment may be in a structure formed by a multiple number of plate materials bonded, for example, by welding. Note that, a cross-sectional shape of the upper rail 4 of the seat slide apparatus for a vehicle according to the embodiment is an example and may be appropriately altered. The lock lever 30 in the seat slide apparatus for a vehicle according to the embodiment may be altered to a lock lever formed by integrating the stem portion 31 and the lock plate 39 into a single component.

A coil spring, a plate spring, or a similar member may be used instead in the seat slide apparatus for a vehicle according to the embodiment to serve as the lock spring 50. A fixing relationship between the lower rail 3 and the upper rail 4 or between the vehicle floor 2 and the seat 5 in the seat slide apparatus for a vehicle according to the embodiment may be reversed. In other words, a configurational relationship in the upward-downward direction between the lower rail 3 and the upper rail 4 or between the vehicle floor 2 and the seat 5 in the seat slide apparatus for a vehicle according to the embodiment may be reversed. In such a case, an operation to unlock the lock lever 30 arranged at a position close to the vehicle floor 2 may be operated through an appropriate operating member, for example, via a cable.

Number of the lower rails 3 and the upper rails 4 to form the seat slide apparatus for a vehicle according to the embodiment may be altered. An alternative configuration of the seat slide apparatus for a vehicle may be provided with one each of the lower rail 3 and the upper rail 4 for the seat 5. Another alternative configuration of the seat slide apparatus for a vehicle may be provided with three or more of the lower rails 3 and three or more of the upper rails 4 for the seat 5.

The direction of the relative movement between the lower rail 3 and the upper rail 4 in the seat slide apparatus for a vehicle according to the embodiment may be altered such that the relative movement between the lower rail 3 and the upper rail 4, for example, is in the vehicle width direction.

According an aspect of this disclosure, a seat slide apparatus for a vehicle includes a first rail (a lower rail 3) including a pair of flanges 13 arranged side by side in a width direction where an end of each of the pair of flanges 13 is formed with a multiple number of locking protrusions 13b, a second rail (an upper rail 4) connected to the first rail (the lower rail 3) to be relatively movable, a lock member (a lock lever 30) connected to the second rail (the upper rail 4) to rotate about an axis extending in the width direction, the lock member (the lock lever 30) formed with a locking portion (locking through-holes 39b) configured to receive the locking protrusion 13b to fit into the locking portion (the locking through-holes 39b), the lock member (the lock lever 30) selectively locking and restricting relative movement between the first rail (the lower rail 3) and the second rail (the upper rail 4) by the locking protrusion 13b removably fitting into the locking portion (the locking through-holes 39b) in response to rotational movement of the lock member (the lock lever 30), a pair of resilient members (extending portions 51 including a first extending portion 51A and a second extending portion 51B) rotationally biasing the lock member (the lock lever 30) in a direction to lock and restrict the relative movement between the first rail (the lower rail 3) and the second rail (the upper rail 4), and an operation member (a release handle 6) configured to transmit an operational force to the lock member (the lock lever 30) for releasing the first rail (the lower rail 3) and the second rail (the upper rail 4) from a locked and restricted state to allow the relative movement between the first rail (the lower rail 3) and the second rail (the upper rail 4). The lock member (the lock lever 30) connects to the second rail (the upper rail 4) to be rotatable about a retaining shaft 22 positioned at the axis extending in the width direction, the retaining shaft 22 fixed to either one of the second rail (the upper rail 4) and the lock member (the lock lever 30) and rotationally supports the other one of the second rail (the upper rail 4) and the lock member (the lock lever 30). Each of the mentioned pair of resilient members (the extending portions 51 including the first extending portion 51A and the second extending portion 51B) includes a shaft biasing portion (a wedging portion 53) biasing the retaining shaft 22 in a direction opposite to a direction of biasing the lock member (the lock lever 30) and includes a first and a second end portions (a lever-side locking end portion 54, a rail-side locking end portion 55) arranged at positions arranging the shaft biasing portion (a wedging portion 53) between the first and the second end portions (the lever-side locking end portion 54, the rail-side locking end portion 55) where the first end portion (the lever-side locking end portion 54) is locked and restrained to the lock member (the lock lever 30) and the second end portion (the rail-side locking end portion 55) is locked and restrained to the second rail (the upper rail 4). A first resilient member (the first extending portion 51A) of the mentioned pair of resilient members (the extending portions 51) includes a stress concentrating portion 56 concentrating stress greater than the stress at a second resilient member (the second extending portion 51B) of the mentioned pair of resilient members (the extending portions 51 including the first extending portion 51A and the second extending portion 51B), the stress concentrating portion 56 arranged on the shaft biasing portion (the wedging portion 53) at one side in the direction of the relative movement between the first rail (the lower rail 3) and the second rail (the upper rail 4). The first rail (the lower rail 3) is provided with a multiple number of engaging portions (engaging through-holes 17) arranged next to each other and aligning in a direction of the relative movement between the first rail (the lower rail 3) and the second rail (the upper rail 4), the engaging portions (the engaging through-holes 17) configured to engage with the stress concentrating portion 56 of the first resilient member (first extending portions 51A) released from the retaining shaft 22.

Upon the arrangement described herewith, in a state where each of the resilient members (the extending portions 51 including the first extending portion 51A and the second extending portion 51B) is used over an allowable stress limit or used more than a number of times defined as a fatigue limit, the first resilient member (the first extending portion 51A) including the stress concentrating portion 56 is likely to break off at the stress concentrating portion 56. When the first resilient member (the first extending portion 51A) breaks off at the stress concentrating portion 56, the stress concentrating portion 56, which is a break off portion released from the retaining shaft 22, is resiliently restored and becomes engageable with any one of a multiple number of engaging portions (engaging through-holes 17). Accordingly, movement in the direction of the relative movement between the first rail (the lower rail 3) and the second rail (the upper rail 4) of either the second rail (the upper rail 4) or the lock member (the lock lever 30) is locked and restrained relative to the first rail (the lower rail 3), the second rail (the upper rail 4) or the lock member (the lock lever 30) that is where an end portion of the first resilient member (the first extending portion 51A), which is connected to the stress concentrating portion 56, is fixed at. Note that, the stress concentrating portion 56 is the break off portion. A movement restrained state produced by the stress concentrating portion 56, which is the break off portion, is not releasable by an operational force exerted from the operation member (the release handle 6). Accordingly, a user is informed of an abnormal condition and recognizes the abnormal condition at a time at which the operation member (the release handle 6) is operated next time at latest. Furthermore, the lock member (the lock lever 30) is rotationally biased in the direction to lock and restrain the relative movement between the first rail (the lower rail 3) and the second rail (the upper rail 4) by the second resilient member (second extending portion 61B) provided without the stress concentrating portion 56, the second resilient member (second extending portion 51B) that is not broken off. Accordingly, the locked and restrained state of the relative movement between the first rail (the lower rail 3) and the second rail (the upper rail 4) provided by the lock member (the lock lever 30) becoming unstable may be restrained. As described above, the end portions of each of the resilient members (the extending portions 51 including the first extending portion 51A and the second extending portion 51B) is locked and restrained to the lock member (the lock lever 30) and the second rail (the upper rail 4). Note that, a state of being “locked and restrained” includes, for example, a state of being engaged and a state of being in contact with each other. Note that, at least one end portion of each of the resilient members (extending portions 51 including the first extending portion 51A and the second extending portion 51B) is in a state of engagement.

According to another aspect of this disclosure, the mentioned pair of resilient members (the extending portions 51 including the first extending portion 51A and the second extending portion 51B) of the seat slide apparatus for a vehicle form a lock spring 50 by connecting between either the first end portions (the lever-side locking end portions 54) or the second end portions (the rail-side locking end portions 55) of the mentioned pair of resilient members (the extending portions 51 including the first extending portion 51A and the second extending portion 51B).

Integrating the mentioned pair of resilient members (the extending portions 51 including the first extending portion 51A and the second extending portion 51B) into a lock spring 50 is advantageous in reducing number of components.

According to further aspect of this disclosure, the shaft biasing portion (the wedging portion 53) of the seat slide apparatus for a vehicle includes a wedging portion 53 in pressure contact with the retaining shaft 22 at each side in the direction of the relative movement between the first rail (the lower rail 3) and the second rail (the upper rail 4). A portion of the wedging portion 53 in pressure contact with the retaining shaft 22 at one side in the direction of the relative movement between the first rail (the lower rail 3) and the second rail (the upper rail 4) becomes the stress concentrating portion 56 by arranging a slant angle θ1 formed between a first direction of tangential line T1 and a biasing direction of the wedging portion 53 to form an angle closer to a right angle compared to a slant angle θ2 formed between a second direction of tangential line T2 and the biasing direction of the wedging portion 53, where the first direction of tangential line T1 is defined at the portion of the wedging portion 53 in pressure contact with the retaining shaft 22 at the mentioned one side in the direction of the relative movement between the first rail (the lower rail 3) and the second rail (the upper rail 4) and the second direction of tangential line T2 is defined at the portion of the wedging portion 53 in pressure contact with the retaining shaft 22 at an opposite side relative to the mentioned one side in the direction of the relative movement between the first rail (the lower rail 3) and the second rail (the upper rail 4).

Accordingly, the stress concentrating portion 56 may be provided with simple adjustment of the slant angles θ1, θ2 formed between the first and the second directions of tangential lines T1, T2 at the portions of the wedging portion 53 in pressure contact with the retaining shaft 22 at each side and the biasing direction of the wedging portion 53.

According to further aspect of this disclosure, the engaging portions (the engaging through-holes 17) of the seat slide apparatus for a vehicle are formed as engaging through-holes 17 that are through-holes extending through the first rail (the lower rail 3).

Accordingly, the stress concentrating portion 56, which is the break off portion, of the first resilient member (the first extending portion 51A) released from the retaining shaft 22 fits into any one of the multiple number of engaging portions (the engaging through-holes 17) when the first resilient member (the first extending portion 51A) breaks off at the stress concentrating portion 56 so that the movement of either the second rail (the upper rail 4) or the lock member (the lock lever 30) in the direction of the relative movement between the first rail (the lower rail 3) and the second rail (the upper rail 4) is locked and restrained. At this time, the stress concentrating portion 56 fitted into the engaging portion (the engaging through-hole 17) is exposed to outside of the first rail (the lower rail 3) by the stress concentrating portion 56 penetrating through the engaging portion (the engaging through-hole 17). Accordingly, the stress concentrating portion 56 may be pushed out from the engaging portion (the engaging through-hole 17) by using an appropriate tool so that the second rail (the upper rail 4) or the lock member (the lock lever 30) is released from a state of being locked and restrained by the stress concentrating portion 56 to allow movement of the second rail (the upper rail 4) or the lock member (the lock lever 30) in the direction of the relative movement between the first rail (the lower rail 3) and the second rail (the upper rail 4) with an easy procedure. Accordingly, a work efficiency for replacing the first resilient member (the first extending portion 51A), which is broken off at the stress concentrating portion 56, may be enhanced.

According to further aspect of this disclosure, the first resilient member (the first extending portion 51A) of the seat slide apparatus for a vehicle is arranged to include the stress concentrating portion 56 by providing resilient deformation of the first resilient member (the first extending portion 51A) from a free state of the first resilient member (the first extending portion 51A) greater than resilient deformation of the second resilient member (the second extending portion 51B) from a free state of the second resilient member (the second extending portion 51B) within an operation range of the lock member (the lock lever 30).

Accordingly, the stress concentrating portion 56 may be provided with a simple adjustment of the amount of resilient deformation of the first resilient member (the first extending portion 51A) and the second resilient member (the second extending portion 51B) relative to free states of each of the first resilient member (the first extending portion 51A) and the second resilient member (the second extending portion 51B) within an operation range of the lock member (the lock lever 30).

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A seat slide apparatus for a vehicle, comprising:
a first rail including a pair of flanges arranged side by side in a width direction where an end of each of the pair of flanges is formed with a plurality of locking protrusions;
a second rail connected to the first rail to be relatively movable;
a lock member connected to the second rail to rotate about an axis extending in the width direction, the lock member formed with a locking portion configured to receive the locking protrusion to fit into the locking portion, the lock member selectively locking and restricting relative movement between the first rail and the second rail by the locking protrusion removably fitting into the locking portion in response to rotational movement of the lock member;
a pair of resilient members rotationally biasing the lock member in a direction to lock and restrict the relative movement between the first rail and the second rail; and
an operation member configured to transmit an operational force to the lock member for releasing the first rail and the second rail from a locked and restricted state to allow the relative movement between the first rail and the second rail, wherein
the lock member connects to the second rail to be rotatable about a retaining shaft positioned at the axis extending in the width direction, the retaining shaft fixed to either one of the second rail and the lock member and rotationally supports the other one of the second rail and the lock member, wherein
each of the pair of resilient members includes a shaft biasing portion biasing the retaining shaft in a direction opposite to a direction of biasing the lock member and includes a first and a second end portions arranged at positions arranging the shaft biasing portion between the first and the second end portions where the first end portion is locked and restrained to the lock member and the second end portion is locked and restrained to the second rail, wherein
a first resilient member of the pair of resilient members includes a stress concentrating portion concentrating stress greater than the stress at a second resilient member of the pair of resilient members, the stress concentrating portion arranged on the shaft biasing portion at one side in the direction of the relative movement between the first rail and the second rail, and wherein
the first rail is provided with a plurality of engaging portions arranged next to each other and aligning in a direction of the relative movement between the first rail and the second rail, the engaging portions configured to engage with the stress concentrating portion of the first resilient member released from the retaining shaft.

2. The seat slide apparatus for a vehicle according to claim 1, wherein
the pair of resilient members form a lock spring by connecting between either the first end portions or the second end portions of the pair of resilient members.

3. The seat slide apparatus for a vehicle according to claim 1, wherein
the shaft biasing portion includes a wedging portion in pressure contact with the retaining shaft at each side in the direction of the relative movement between the first rail and the second rail, and wherein
a portion of the wedging portion in pressure contact with the retaining shaft at one side in the direction of the relative movement between the first rail and the second rail becomes the stress concentrating portion by arranging a slant angle formed between a first direction of tangential line and a biasing direction of the wedging portion to form an angle closer to a right angle compared to a slant angle formed between a second direction of tangential line and the biasing direction of the wedging portion, where the first direction of tangential line is defined at the portion of the wedging portion in pressure contact with the retaining shaft at the one side in the direction of the relative movement between the first rail and the second rail and the second direction of tangential line is defined at the portion of the wedging portion in pressure contact with the retaining shaft at an opposite side relative to the one side in the direction of the relative movement between the first rail and the second rail.

4. The seat slide apparatus for a vehicle according to claim 2, wherein
the shaft biasing portion includes a wedging portion in pressure contact with the retaining shaft at each side in the direction of the relative movement between the first rail and the second rail, and wherein
a portion of the wedging portion in pressure contact with the retaining shaft at one side in the direction of the relative movement between the first rail and the second rail becomes the stress concentrating portion by arranging a slant angle formed between a first direction of tangential line and a biasing direction of the wedging portion to form an angle closer to a right angle compared to a slant angle formed between a second direction of tangential line and the biasing direction of the wedging portion, where the first direction of tangential line is defined at the portion of the wedging portion in pressure contact with the retaining shaft at the one side in the direction of the relative movement between the first rail and the second rail and the second direction of tangential line is defined at the portion of the wedging portion in pressure contact with the retaining shaft at an opposite side relative to the one side in the direction of the relative movement between the first rail and the second rail.

5. The seat slide apparatus for a vehicle according to claim 1, wherein
the engaging portions are formed as engaging through-holes that are through-holes extending through the first rail.

6. The seat slide apparatus for a vehicle according to claim 2, wherein
the engaging portions are formed as engaging through-holes that are through-holes extending through the first rail.

7. The seat slide apparatus for a vehicle according to claim 3, wherein
the engaging portions are formed as engaging through-holes that are through-holes extending through the first rail.

8. The seat slide apparatus for a vehicle according to claim 4, wherein
the engaging portions are formed as engaging through-holes that are through-holes extending through the first rail.

9. The seat slide apparatus for a vehicle according to claim 1, wherein
the first resilient member is arranged to include the stress concentrating portion by providing resilient deformation of the first resilient member from a free state of the first resilient member greater than resilient deformation of the second resilient member from a free state of the second resilient member within an operation range of the lock member.

10. The seat slide apparatus for a vehicle according to claim 2, wherein
the first resilient member is arranged to include the stress concentrating portion by providing resilient deformation of the first resilient member from a free state of the first resilient member greater than resilient deformation of the second resilient member from a free state of the second resilient member within an operation range of the lock member.

11. The seat slide apparatus for a vehicle according to claim 3, wherein
the first resilient member is arranged to include the stress concentrating portion by providing resilient deformation of the first resilient member from a free state of the first resilient member greater than resilient deformation of the second resilient member from a free state of the second resilient member within an operation range of the lock member.

12. The seat slide apparatus for a vehicle according to claim 4, wherein
the first resilient member is arranged to include the stress concentrating portion by providing resilient deformation of the first resilient member from a free state of the first resilient member greater than resilient deformation of the second resilient member from a free state of the second resilient member within an operation range of the lock member.

13. The seat slide apparatus for a vehicle according to claim 5, wherein
the first resilient member is arranged to include the stress concentrating portion by providing resilient deformation of the first resilient member from a free state of the first resilient member greater than resilient deformation of the second resilient member from a free state of the second resilient member within an operation range of the lock member.

14. The seat slide apparatus for a vehicle according to claim 6, wherein
the first resilient member is arranged to include the stress concentrating portion by providing resilient deformation of the first resilient member from a free state of the first resilient member greater than resilient deformation of the second resilient member from a free state of the second resilient member within an operation range of the lock member.

15. The seat slide apparatus for a vehicle according to claim 7, wherein
the first resilient member is arranged to include the stress concentrating portion by providing resilient deformation of the first resilient member from a free state of the first resilient member greater than resilient deformation of the second resilient member from a free state of the second resilient member within an operation range of the lock member.

16. The seat slide apparatus for a vehicle according to claim 8, wherein
the first resilient member is arranged to include the stress concentrating portion by providing resilient deformation of the first resilient member from a free state of the first resilient member greater than resilient deformation of the second resilient member from a free state of the second resilient member within an operation range of the lock member.
